(19) United States
(12) Patent Application Publication
(10) Pub. No.: US 2002/0014805 A1
(43) Pub. Date: Feb. 7, 2002

(54) Combination type motor

(76) Inventor: Bun-Liou Liau, Taipei (TW)

Correspondence Address: WINSTON HSU, SF. 389, FU-HO ROAD, YUNGHO CITY, TAIPEI, TW

(21) Appl. No.: 09/740,896

(22) Filed: Dec. 21, 2000

(30) Foreign Application Priority Data
Aug. 4, 2000 (TW) 089115669

(51) Int. Cl. H02K 3/00

(52) U.S. Cl. 310/179

(57) ABSTRACT

A combination type motor includes a stator and an armature. The stator has serial windings and parallel windings, installed on the opposing sides of the motor, to create a magnetic field. The armature, installed between the serial windings and parallel windings, provides a torque to drive a carrier. The parallel windings are connected in parallel to the armature to form a parallel circuit and in turn, the parallel circuit is connected in series to the serial windings to form a combination circuit.

### BACKGROUND OF THE INVENTION

1. Field of the invention

The present invention relates to a combination type motor, and more particularly, to a combination type motor with characteristics of both a universal motor and a DC brush motor.

2. Description of the prior art

The operation of an office electrical paper shredder or a paper punch is based on a motor. The motor can be a universal motor, a DC brush motor or an induction motor, each having different characteristics and thus used in different fields.

The advantage of a universal motor is its low cost but its high rotating speed, under zero load condition, is a disadvantage. A 150-W universal motor can reach up to 10,000 rotations per minute without a load, creating a large amount of noise. As well, under a load condition, the rotating speed of a universal motor is dramatically reduced. The variation in rotating speeds of the paper shredders or paper punches, under changing load conditions, can affect the operating function of these machines.

The advantages of a DC brush motor are its low cost, relatively low rotating speed, and low-level noise of operation. As well, the rotating speed of the DC brush motor remains relatively fixed under changing load conditions. However, due to its low rotating speed, a DC brush motor is unable to provide enough torque to drive the paper shredder or the paper punch. Thus, although low in cost, the application of the DC brush motor is limited.

An induction motor is attractive in appearance but lacks popularity due to its high cost and large physical size.

### SUMMARY OF THE INVENTION

It is an object of the present invention to provide a combination type motor with advantages of both the universal motor and DC brush motor to solve the problems mentioned above.

In accordance with the claimed invention, a combination type motor includes a stator having serial windings and parallel windings to create a magnetic field, and an armature installed between the serial windings and parallel windings to provide a torque to drive a carrier.

It is an advantage of the present invention that the rotating speed of the combination type motor is high but results in low noise operation, so that it can be applied in a large number of fields.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a schematic diagram of a combination type motor of the present invention.

FIG. 2 is an enlarged view of the components of the combination type motor of FIG. 1.

FIG. 3 is a circuit diagram of the combination type motor of FIG. 1.

### DETAILED DESCRIPTION OF THE PREFERRED EMBODIMENT

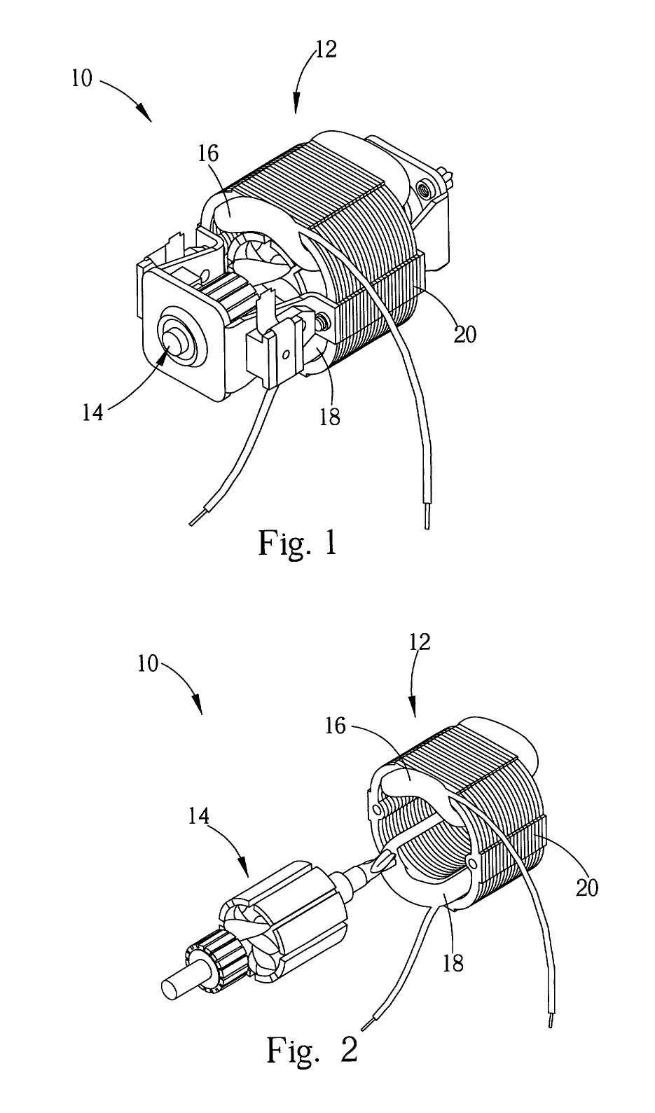

Please refer to FIG. 1 and FIG. 2. FIG. 1 is a schematic diagram of a combination type motor 10 of the present invention and FIG. 2 is an enlarged view of the components of the combination type motor 10 of FIG. 1. The combination type motor 10 is a DC motor that includes a stator 12 and an armature 14.

The stator 12 is made up of serial windings 16 and parallel windings 18, installed on the opposing sides of the motor 10, to create a magnetic field. The stator 12 also comprises a metal ring 20, of silicon steel or soft iron, to enhance the magnetic field created by the serial windings 16 and parallel windings 18 and to provide a torque to drive a carrier.

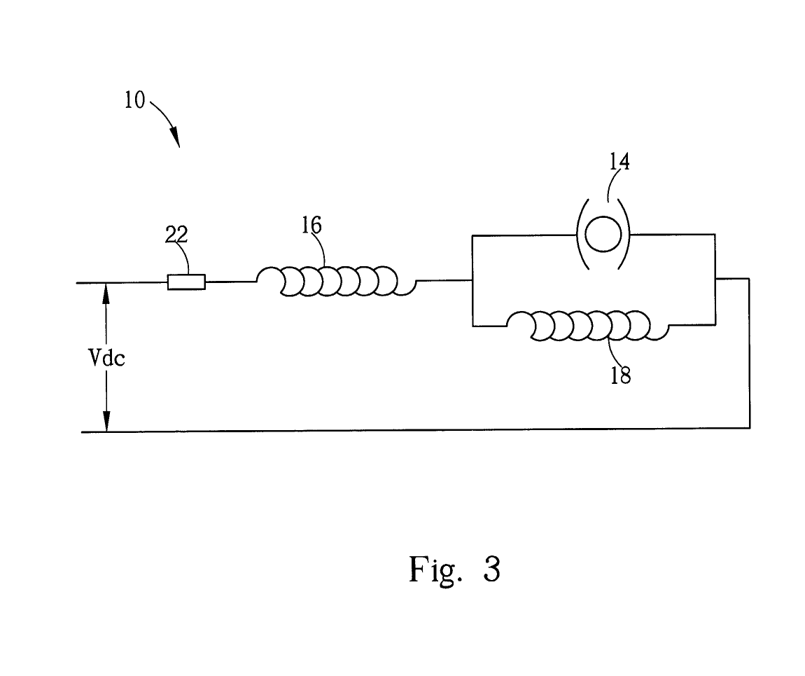

Please refer to FIG. 3. FIG. 3 is a circuit diagram of the combination type motor 10 of FIG. 1. As shown in FIG. 3, the parallel windings 18 are connected in parallel to the armature 14 to form a parallel circuit. The parallel circuit is then connected in series to the serial windings 16 to form a combination circuit. The combination type motor 10 further includes a thermal protector 22, connected in series to the combination circuit, to protect the combination type motor 10 and to prevent circuit overheating.

The armature 14 of the combination type motor 10 is connected in parallel to the parallel windings 18 and connected in series to the serial windings 16 and has characteristics of both the universal motor and DC brush motor. The resistance of the serial windings 16 and parallel windings 18 can be changed by adjusting the thickness of the windings 16,18. As a result, the combination type motor 10 can be adjusted to function as a universal-oriented motor or a DC brush-oriented motor.

In the preferred embodiment of the present invention, the parallel windings 18 are thinner than the serial windings 16. For a 150-W combination type motor 10 with no load, its rotating speed is approximately 3000 to 4000 rotations per minute and with a load, its rotating speed is approximately 2000 rotations per minute and has the ability to produce a torque above 5 kg-cm/A.

In comparison with a prior art universal motor, the combination type motor 10 with no load has a lower rotating speed and produces less noise. The combination type motor 10 with a load, has a decreased rotating speed to produce a large torque. The difference in the rotating speed of the combination type motor 10 with or without a load is less than that of the universal motor.

In comparison with a prior art DC brush motor, the combination type motor 10 is able to produce enough torque to drive a paper shredder or a paper punch. Thus, the combination type motor 10 has advantages of both the universal motor and the DC brush motor but without their problems.

In comparison with a prior art induction motor, the combination type motor 10 costs 40 percent less and is smaller in size. Thus, the combination type motor 10 can be applied to many different fields.

Those skilled in the art will readily observe that numerous modifications and alterations of the device may be made while retaining the teachings of the invention, Accordingly, the above disclosure should be construed as limited only by the metes and the bounds of the appended claims.

What is claimed is:

1. A combination type motor comprising:
a stator comprising serial windings and parallel windings, installed on the opposing sides of the motor, to create a magnetic field;
an armature installed between the serial windings and parallel windings to provide a torque to drive a carrier;
wherein the parallel windings are connected in parallel to the armature to form a parallel circuit;
the parallel circuit is connected in series to the serial windings to form a combination circuit.

2. The combination type motor of claim 1 wherein windings of the parallel windings are thinner than those of the serial windings.

3. The combination type motor of claim 1 further comprising a thermal protector, connected in parallel to the combination circuit, to protect the motor.

4. The combination type motor of claim 1 being a DC motor.

5. The combination type motor of claim 1 wherein the stator comprises a metal ring to enhance the magnetic field created by the serial windings and parallel windings.

6. The combination type motor of claim 5 wherein the metal ring is formed by silicon steel or soft iron.
